(19) United States
(12) Patent Application Publication
(10) Pub. No.: US 2009/0250938 A1
(43) Pub. Date: Oct. 8, 2009

(54) Wind turbine incorporated in an electric transmission tower

(76) Inventor: George G. Stone, JR., Rockingham, NC (US)

Correspondence Address: Robert C. Curfiss, 19826 Sundance Drive, Humble, TX, 77346-1402, US

(21) Appl. No.: 12/315,121

(22) Filed: Nov. 28, 2008

Related U.S. Application Data
(60) Provisional application No. 60/990,747, filed on Nov. 28, 2007.

(51) Int. Cl. F03D 9/00

(52) U.S. Cl. 290/55

(57) ABSTRACT

An electric generation device such as a vertical axis wind turbine is installed in existing structures like electric transmission towers to provide a source of “green” energy, without significantly impeding power generation and without creating additional impact on the landscape or environment, and without significantly obstructing the public view. This system has direct access to the electric grid at the tower where installed and provides many environmental benefits. Specifically, the system would not require the use of additional land or space and would not require additional transmission lines over a new right-of-way to transmit the power so generated to the grid.

### CROSS REFERENCE TO RELATED APPLICATION

This application is related to and claims priority base on the U.S. Provisional Application No. 60/990,747, filed on Nov. 28, 2007, entitled: DISGUISE ELECTRIC GENERATION EQUIPMENT BY INSTALLING IN EXISTING STRUCTURES LIKE ELECTRIC TRANSMISSION TOWERS”, which provisional application is incorporated by reference herein as if fully repeated.

### BACKGROUND OF THE INVENTION

1. Field of the Invention

The invention is generally related to a method and apparatus for incorporating “green” energy sources into the power grid and is specifically directed to the incorporation of a wind turbine into the architecture of an electric transmission tower.

2. Discussion of the Prior Art

In the last several years it has become more and more desirable to identify and utilize energy sources which are not dependent upon fossil fuels. This is not only because of global warming which is, in part, due to the emissions caused by use of fossil fuels, but also to take advantage of sources which may be more efficient in the long run.

The use of wind turbines is well known. For the most part wind turbines have blades which rotate around a horizontal axis (HAWT). Such wind turbines are generally located in wind farms and the very large current (or the grid at point of access) generated by the combined turbines must be modified and adapted in order to be connected to the existing power grid, eventually utilizing relatively standard transmission lines.

More recently, vertical axis wind turbines (VAWT) have become available. U.S. Pat. No. 7,303,369 discloses a lift and drag-based vertical axis wind turbine in which the vertical axis and foils mounted thereon are magnetically levitated above the turbine's base, thereby reducing friction within the system. The foils are shaped to maximize operation of the system, regardless of the wind direction. More specifically, the foils are three-dimensionally shaped about the vertical axis so as to resemble the billowed sail of a sailing ship. The sails (or vanes) capture wind through a full 360 degrees of rotation under any wind condition. The system is further provided with an axial-flux alternator using variable resistance coils which can be individually and selectively turned on or off depending on wind conditions and required electrical draw requirements. The coils can also be used to produce mechanical drag on the system if required to brake the turbine in high wind conditions or for maintenance. The system may be programmed to assess whether electricity generated by the system can be or should be transmitted to a public grid or stored locally on a chargeable battery system. Finally, the system may be programmed to report system usage such as the amount of electricity produced, the amount of electricity used and the amount of electricity sent to a grid or stored. Likewise, the system can report outages to individuals and local authorities.

Typical electric transmission towers are usually steel lattice structures used to support overhead electricity conductors for electric power transmission. Lattice towers can be assembled horizontally on the ground and erected by push-pull cable, but this method is rarely used because of the large assembly area needed. Lattice towers are more usually erected using a crane or using gin pole method or using a derrick or in very inaccessible areas, a helicopter.

It would be desirable to incorporate a power generating system directly into the towers to both reduce the expense and footprint of transmitting power generated by wind turbines and the like and to make the systems more efficient by reducing power loss experienced when transmitting the power over great distances.

### SUMMARY OF THE INVENTION

The system of the subject invention provides a method and apparatus for reducing the visibility and obtrusiveness of green electric power generation equipment to supply the electric grid or for local use. In this example this is done by utilizing a typical electric transmission tower with a platform mounted within the tower for supporting a green energy powers source such as, by way of example, a vertical axis wind turbine in the tower and connecting the power generated at the vertical axis wind turbine to the grid at the towers. Typically, the vertical axis wind turbine is mounted above ground level in the tower to take advantage of prevailing wind patterns. The power generation system may include a controller for selectively connecting the power generated by the vertical axis wind turbine to the grid. The vertical axis wind turbine may be constructed of various vertically assembled modules to facilitate installation of the vertical axis wind turbine in the tower.

The present invention relates to electric generation equipment in this example by installing a vertical axis wind turbine in existing structures like electric transmission towers. This would not significantly impede power generation and would not create additional impact on the landscape or environment.

One example of this device is comprised of the following components:
Narrow Radius Wind Turbine or other generation equipment
A narrow radius electric generator (such as a vertical axis wind turbine (VAWT)) designed to fit within existing towers on existing rights of way.
Electrical Company Partnership

This system has direct access to the electric grid in the towers where it is installed and provides many environmental benefits. Specifically, the system would not require the use of additional land or space, would not require additional transmission lines over a new right-of-way to transmit the power so generated to the grid and would not create eyesores subject to negative public opinion.

In the example embodiment, a VAWT is mounted in existing electric transmission towers in those locations with the most effective combination of turbine size, mounting height (access to winds aloft) and average winds for maximum generation of electricity. The system of the subject invention provides a worldwide platform for alternative, green power generation.

Further, by incorporating the VAWT in an electric transmission tower, the efficiency of the VAWT is potentially increased by taking more advantage of higher velocity, more unrestricted airflow without requiring the costs associated with building a structure to reach desired heights. It should be understood that other green energy sources such as solar panels and the like could also be utilized in this manner.

The system of the subject invention significantly reduces the requirements for additional disturbance to the visual and physical environment by occupying space within existing structures. The system of the subject invention also minimizes any additional impact on nature and the visual landscape that would be created by installing a cluster of generation equipment.

### BRIEF DESCRIPTION OF THE DRAWINGS

FIG. 1 is a typical electric transmission tower with a VAWT installed directly therein.

FIG. 2 is a view looking generally in the same direction as FIG. 1, showing the method of installing the VAWT in the tower.

FIG. 3 is an example of a VAWT of the type suited to be installed in a typical electric transmission tower.

FIG. 4 is a flow chart of the VAWT power transmission system coupled to the grid at the integrated electric transmission tower location.

### DESCRIPTION OF THE EXAMPLE EMBODIMENT

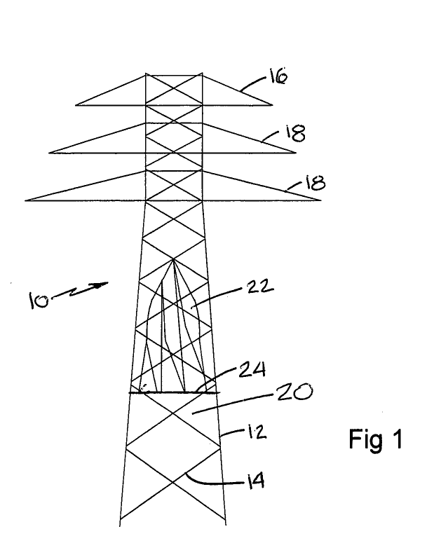

A typical transmission tower 10 is shown in FIG. 1. The tower is typically constructed of vertical standards 14 connected in a rigid assembly by lattice work 14. Generally, the tower is of a rectangular cross-section with all four sides being virtually identical in construction. The top of the tower includes one-or more arm extensions 16, 18 for carrying transmission lines, not shown. The interior space 20 of the tower is usually open and unrestricted.

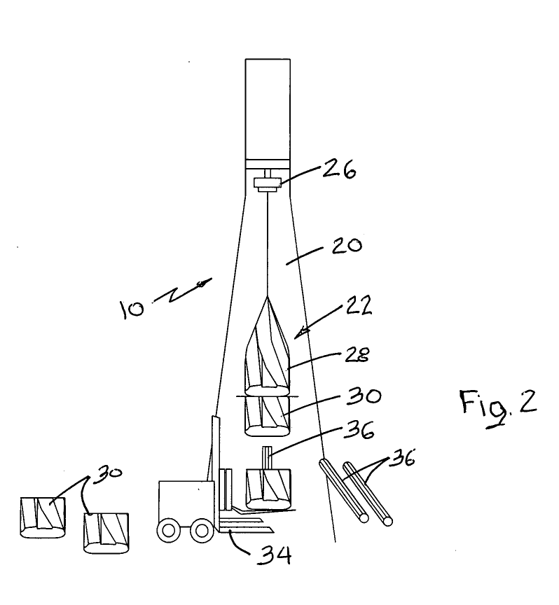

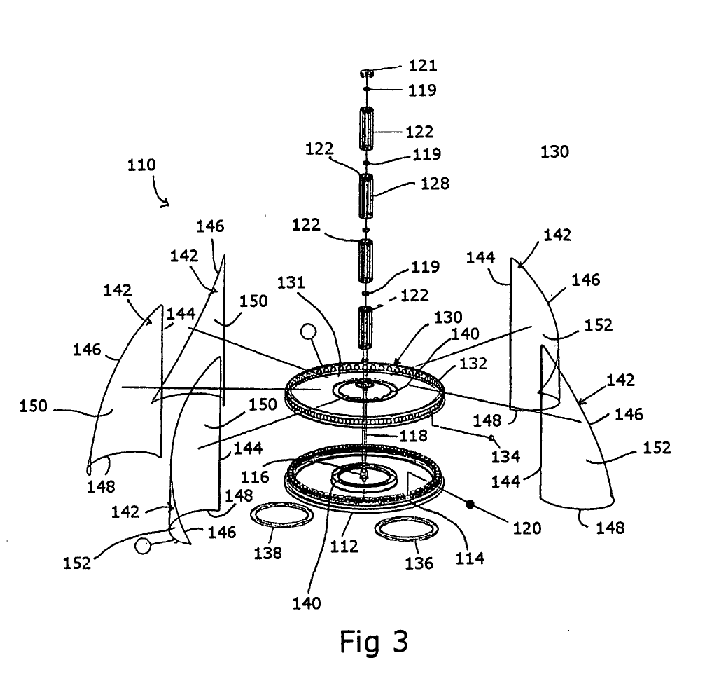

In the subject invention, a VAWT 22 is installed in the interior space 20 of the tower and connected through a smart inverter directly to the power grid by connecting the power transmission cables from the VAWT to the grid at the arm extensions 16, 18. In the preferred embodiment the VAWT is mounted on a platform 24 which is rigidly mounted within the transmission tower. As shown in FIG. 2, the VAWT is broken into a number of modules which are assembled and installed at the site. The lattice work has been deleted from the view for purposes of clarity. A forklift 34 is used to transport the sail modules 28, 30 32 under the lattice structure into the tower interior, and place it on the base platform 24. Then each module is lifted with the hoist to allow the next module section to be placed on the platform below it to be attached to the preceding module. Then the hoist lowers the previous module or module assembly over the sail coupling shaft 36 that has been inserted into the module on the platform and the modules are connected together in perfect alignment. The process is continued until the module stack is complete and attached to the base module containing the axial-flux alternator (see FIG. 3). This assembly process is also avoids exposure to the high voltage power lines above.

A typical VAWT system is shown and described in U.S. Pat. No. 7,303,369 and is shown in FIG. 3, as adapted for tower installation. Specifically, there is shown a substantially circular base 112 defined by a vertical edge 114 at its outer perimeter and a central hub 116. The base rests directly on the platform 24 provided in the tower. A center rod 118 attaches to central hub 116 and extends axially from base 112. Disposed around outer perimeter of base 112 on vertical edge 114 is a plurality of magnetic transformers 120. An axial shaft 122 having a first end, a second end and axial grooves 28 along its length is pivotally mounted on center rod 118. Shaft 122 rotates axially relative to rod 118 and base 112. Center bearings 119 may be positioned on rod 118 or within shaft 122 to facilitate relative rotation and ensure axial alignment of shaft 122 and rod 118. The shaft 122 is segmented into multiple segments and multiple bearings 119 are utilized so that the height of shaft 122 can be adjusted as desired, and so that the system can be assembled in modules as required for the tower installation. The top cap 121 may be placed over the top most center bearing 119.

Mounted on shaft 122 is a substantially circular rotor or cover 130 which has an outwardly extending surface 131 terminating at an outer perimeter vertical edge 132. Disposed around the outer perimeter edge 132 of rotor 130 is a plurality of magnets 134. Rotor 130 is mounted on shaft 122 so as to be concentric with base 112, whereby the outer perimeter edge 132 of rotor 130 is adjacent the outer perimeter edge 114 of base 112 such that magnets 134 are aligned with transformers 120 in a horizontal plane. Center rod 118, being attached in a fixed non-rotational position to base 112, in addition to providing support for shaft 122 and rotor 130, also provides alignment for base 112 and rotor 130 and hence the adjacent transformers 120 and magnets 134.

A first levitating magnet 136 is mounted on base 112 and a second levitating magnet 138 is mounted on rotor 130 so that magnet 136 and magnet 138 are adjacent one another when rotor 130 and base 112 are axially aligned. Those skilled in the art will understand that the polarities of magnets 136 and 138 are such that the magnets repel one another when mounted as described herein. In such case, rotor 130 will “levitate” above base 112 on center rod 118. The levitating magnets 136, 138 enable rotor 130 and vanes 142, or wind turbine portion of the device, to “levitate” magnetically off of base 112, thus providing substantially frictionless rotation of rotor 130 relative to base 112.

A plurality of triangular shaped vanes 142 are mounted on shaft 122. Each vane 142 is characterized by an inner edge 144, an outer edge 146 and a lower edge 148. The outer edge 146 is curved axially about inner edge 144 so as to define an inner surface 150 and an outer surface 152 for each vane 142. In one preferred embodiment, inner edge 144 is linear, while edges 146 and 148 are curvilinear, thereby taking on the shape of the billowed sail of a sailboat. In any event, inner edge 144 of vane 142 is disposed to mount in an axial groove 128 of shaft 122 so that lower edge 148 abuts rotor 130 and the distal end of lower edge 148 terminates adjacent vertical edge 132 of rotor 130. Vanes 142 are preferably equally spaced about shaft 122 in the same direction radially on top of rotor 130. In one preferred embodiment, eight vanes 142 are utilized. The vanes may be separated into vertical module assemblies 28, 30 and 32 (FIG. 2) and mounted on different shaft segments 122 to facilitate assembly in the tower.

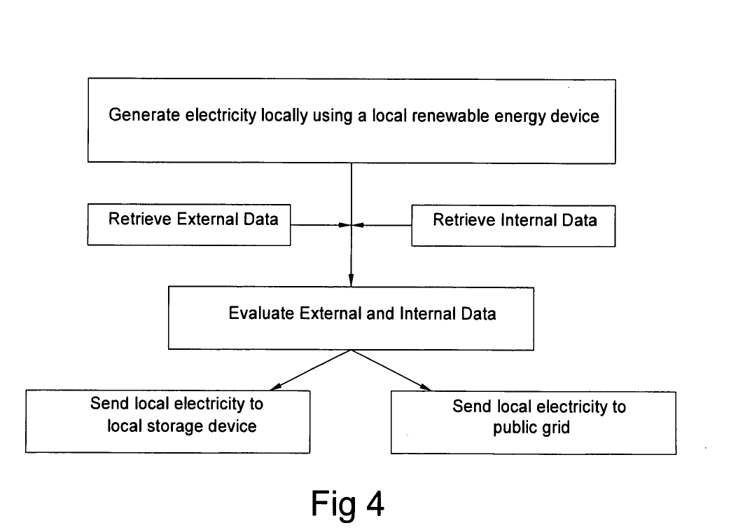

The electrical power generated by the VAWT may then be directly connected to the grid at the tower, or may be utilized locally as well as on the grid. A flow chart for controlling the use of the power so generated is shown in FIG. 4. In this case, a controller, not shown, is incorporated for directing the power to the grid or to the local user. The controller is more fully described in the aforementioned U.S. Pat. No. 7,303,369, which is incorporated by reference herein as if fully repeated.

The controller is programmed to assess whether electricity generated by turbine 22 can be transmitted to a public grid or should be stored locally, such as on a chargeable battery system. More specifically, the controller may be programmed to access or otherwise receive external data related to co-generation, power costs, and the availability of a public grid to receive co-generated electricity from the turbine 22. Once the controller has evaluated these parameters, it can take appropriate action to control the electricity by deciding where to send the electricity. FIG. 4 illustrates for example, if the controller determines it is not profitable to send electricity to a public grid, then the controller may direct the electricity to a local storage device. Likewise, the controller may evaluate the status of a local storage system, such as a large capacity uninterruptible power supply (UPS) and maintain a local database of such. The controller may decide to send some of the electricity to a local utility grid and some to a local storage system. For example, if the local storage system is a rechargeable battery system or a UPS, then the controller, by means of sensors, may determine whether the battery system is charged to 100% of capacity and take appropriate action to recharge to such a level. Local data may also consist of a historical database battery efficiency. Similarly, the controller may also monitor local energy usage and maintain a local database of historical energy usage and thus be ready to provide more energy at peak hours, less energy at off-peak hours, or generate a report or “alert” if the local public grid is anomalous because of usage that could signal an equipment malfunction or other noteworthy condition. This is an important safety feature that can protect both the user of the wind turbine (for electricity generation), and also the electricians and line crews of the electricity-generation utility. It can also assist the utility in mapping or pinpointing localities where a grid outage exists, as discussed further below.

If a local battery system is fully charged, then the controller may evaluate the value of the generated electricity in terms of energy market prices at that moment in terms of the price to efficiency ratio of the other connected storage device(s). The controller then decides whether the return amount of electricity justifies sending the electricity to one or another specific storage device.

Finally, the controller may be programmed to report system usage such as the amount of electricity produced, the amount of electricity used and the amount of electricity sent to a grid or stored. Likewise, the system can report outages to individuals and local authorities. The controller may use a regular telephone line, WLAN, WIFI, or cellular telephone connection to obtain external data and to report both usage and outage conditions. Typically, a usage report would consist of the following: the amount of electricity produced by the wind speed (if equipped with an external anemometer), the amount of electricity used and the amount of electricity sent to the local electrical grid.

Outage reporting may also occur when the meter or safety cut off switch indicates that there is no electricity on the grid side connection. A signal or report to the outage reporting center may be generated to indicate that there has been an outage and to confirm that the unit is no longer sending electricity to the grid. This signal or report may then be passed on to the local utility to create an outage “footprint” or map showing the units reporting the outage and the units not reporting.

While certain features and embodiments of the invention have been described in detail herein, it should be understood that the invention encompasses all modifications and enhancements within the scope and spirit of the following claims.

What is claimed is:

1. A power generation system for providing additional, “green” power to the grid, comprising:
a. an electric transmission tower; and
b. a green energy source mounted in the tower and connected to the grid at the tower.

2. The power generation system of claim 1, wherein the green energy source is a vertical axis wind turbine (VAWT).

3. The power generation system of claim 2, wherein the vertical axis wind turbine is installed on a platform mounted inside the tower.

4. The power generation system of claim 2, wherein the vertical axis wind turbine is mounted above ground level in the tower.

5. The power generation system of claim 1, further including a controller for selectively connecting the power generated by the green energy source to the grid.

6. The power generation system of claim 2, wherein the vertical axis wind turbine is constructed of various vertically assembled modules to facilitate installation of the vertical axis wind turbine in the tower.

7. A power generation system for providing additional, “green” power to the grid, comprising:
a. an electric transmission tower;
b. a platform mounted in the tower
c. a vertical axis wind turbine supported on the platform in the tower and connected to the grid at the tower.

8. The power generation system of claim 6, wherein the vertical axis wind turbine is mounted above ground level inside the tower.

9. The power generation system of claim 6, further including a controller for selectively connecting the power generated by the vertical axis wind turbine to the grid.

10. The power generation system of claim 6, wherein the vertical axis wind turbine is constructed of various vertically assembled modules to facilitate installation of the vertical axis wind turbine in the tower.
